(19) United States
(12) Patent Application Publication
(10) Pub. No.: US 2025/0139426 A1
(43) Pub. Date: May 1, 2025

(54) POWER-SPACE EFFICIENT PHOTONIC FOURIER CONVOLUTIONAL NEURAL NETWORK

(71) Applicant: HEWLETT PACKARD ENTERPRISE DEVELOPMENT LP, Spring, TX (US)

(72) Inventors: Stanley CHEUNG, Milpitas, CA (US); Bassem TOSSOUN, Santa Barbara, CA (US); Yuan YUAN, Milpitas, CA (US); Yiwei PENG, Milpitas, CA (US); Geza KURCZVEIL, Santa Barbara, CA (US)

(21) Appl. No.: 18/497,453

(22) Filed: Oct. 30, 2023

(51) Int. Cl. G06N 3/067; G06F 17/14; G06N 3/0464

(52) U.S. Cl. CPC G06N 3/0675; G06F 17/14; G06N 3/0464

(57) ABSTRACT

Systems and methods are provided for monolithic photonic integrated devices for implementing convolutional neural network (CNN). Examples provide for photonic devices comprising a first optical transform device configured to perform a first transform on input optical signals to output a plurality of intermediate optical signals, a plurality of optical modulation devices configured to perform a convolution on the intermediate optical signals, and second transform device configured to perform a second transform of the plurality of intermediate optical signals and output a plurality of output optical signals. Each of the modulation devices comprises an amplitude modulator and a phase modulator. The photonic device, including an optical source that generates an input optical signal, can be formed monolithically on a common substrate to provide a convolutional optical neural network (CONN) integrated onto a single chip.

### BACKGROUND

Artificial neural networks (“ANNs”) have become a substantial tool for machine learning. ANNs benefit from application in a wide range of fields, such as, but not limited to, image recognition, natural language processing, and gaming, among others. For more complicated tasks, larger and deeper ANNs are becoming more important. These larger and deeper ANNs require faster and more energy-efficient computing hardware.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic block diagram of a system architecture for implementing a CONN in accordance with implementations of the present disclosure.

FIG. 2 is an schematic block diagram of an optical device in accordance with implementations of the present disclosure.

FIGS. 3A and 3B depict example implementations of a first and second transform device in accordance with embodiments disclosed herein.

FIG. 4 is an example flow chart of operations for implementing an optical neural network in accordance with the implementations disclosed herein.

FIG. 5 is an example computing component that may be used to implement various features of implementing an optical neural network in accordance with the implementations disclosed herein.

FIG. 6 is an example computer system that may be used to implement various features of implementing an optical neural network of the present disclosure.

The figures are not exhaustive and do not limit the present disclosure to the precise form disclosed.

### DETAILED DESCRIPTION

The present disclosure provides for monolithic photonic integrated devices for implementing convolutional neural network (CNN). A CNN can be performed using optical Fourier Transforms, which can be conventionally performed by propagation of a lens. Implementations disclosed herein provide for photonic devices comprising optical transform devices configured to perform optical Fourier Transforms, and a plurality of optical modulation devices adapted to perform a convolution. The modulation devices may comprise amplitude modulators and phase modulators. The entire photonic device, including an optical source that generates an input optical signal, can be formed monolithically on a common substrate to provide a convolutional optical neural network (CONN) integrated onto a single chip.

Deep ANNs have found success in a wide variety of applications, ranging from computer vision to natural language processing to game playing. The majority (e.g., up to 80%) of processing overhead in deep-learning networks are CNNs. CNNs are widely deployed for image processing/recognition, autonomous driving, text translation, and facial recognition, among other applications. CNNs may be computationally heavy, with a computational complexity on the order of O(N⁴), where N represents a number of input elements. In the case of a N×N image, where N represents a number of pixels, the complexity scales accordingly. Thus, as CNNs become larger and deeper, they require faster and more energy-efficient computing hardware.

Specifically designed computing hardware platforms, such as graphical processing units (GPUs) and tensor processing units (TPUs), have been developed to address this growing demand for computation resources. However, conventional electronic CNNs have several limitations, including high-energy consumption, limited processing speed, and susceptibility to electromagnetic interference. As a result, CONNs have drawn increasing interest because they rely on light to perform computations and processing, rather than electronic signals. The reliance on light can overcome the above bottlenecks of electronic ANNs. For example, ultra-high-speed optoelectronic devices, such as photodiodes and modulators, can enable operation rates that are one to two orders of magnitude higher than electronic counterparts. Further, the reliance on light can provide CONNs that are resistant to electromagnetic interference, have no length-dependent resistance, and consume low energy. Thus, CONNs have been recognized as a competitive solution due to offering energy-efficient, compact, and high-speed computations.

Some conventional approaches to CONNs have been explored, but are limited in application due to power consumption and physical footprint considerations. For example, one proposed approach utilizes bulk optics to provide a 4f system that consists of a first lens, a phase mask, and a second lens. The first lens is placed one focal distance f away from an object plane to produce a Fourier plane at a focal distance f after the first lens and the second lens is placed one focal distance f away from the Fourier plane. This produces an inverted conjugate image plan at another focal distance f from the second lens (e.g., a total of four focal distance f between object plane and conjugate image plane). A phase map is placed at the Fourier plane for performing a 2D convolution. However, this approach requires a relatively large footprint that is dependent on the focal distance f. For example, one real world implementation provides a total system distance (e.g., four focal distances) of approximately one meter. Additionally, the phase mask consumes power that dominates power consumption considerations.

Accordingly, implementations disclosed herein overcome the above technical shortcomings by providing photonic devices configured to implement CONNs. The implementations disclosed herein can be monolithically integrated on a single substrate, which may be provided as silicon or other Group IV material. The device disclosed herein can thus be provided as a single photonic chip that can be utilized to perform a convolution operation.

In an example of the present disclosure, an optical device is provided that is monolithically formed on a substrate. The optical device comprises a plurality of input waveguides configured to receive input data encoded onto a plurality of optical signals. A first transform device may be coupled to the plurality of input waveguides and configured to perform a first transform of the input optical signals, to output a plurality of intermediate optical signals. A plurality of intermediate waveguides may be coupled to the first transform device and configured to receive the plurality of intermediate optical signals from the first transform device. Each intermediate waveguide may comprise a modulation device, provided as a phase modulator and an amplitude modulator, coupled thereto. A second transform device can be coupled to an output of the intermediate waveguides. The second transform device may receive the plurality of intermediate optical signals and is configured to perform a second transform on the plurality of intermediate optical signals and output a plurality of output optical signals. The second transform may be an inverse transform of the first transform. The plurality of output optical signals can be received by an array of non-linear activation devices and photodetectors that detect an optical power indicative of a classification of the input data. The non-linear activation devices may be activated or not based on the output optical signals, and this activation is detected by the photodetectors as an optical power.

In an illustrative example, a convolution can be defined as r(x)={g*h}(x)=F⁻¹{F{g}(f)·F{h}(f)}, where F and F⁻¹ are the discrete and inverse Fourier transforms, respectively, and “·” is a Hadamard product. The Hadamard product is known as an elementwise matrix multiplication operation. In an example, the first transform device can be configured to perform the first transform as the discrete optical Fourier transform, while the second transform device can be configured to perform the second transform as the inverse discrete optical Fourier transform. As such, the first and second transform devices may be referred to herein as a discrete optical Fourier transform device and inverse discrete optical Fourier transform device, respectively. The first and second transform devices may be implemented as star-couplers, multimode interferometers (MMIs), meshes of Mach-Zehnder Interferometers (MZIs), or the like. The Hadamard product can be implemented using a plurality of modulation devices, each of which can be implemented as a pair of phase and amplitude modulators. The modulation devices can be provided between the first and second transform devices, such that an output from the first transform device (e.g., intermediate optical signals) can be modulated by the optical modulators to implement the Hadamard product. The modulated optical signals can be provided as an input to the second transform device. The output of the second transform device can be fed to an array of non-linear activation functions and photodetectors. The output from the second transform device can be indicative of the convolution of input data encoded onto optical signals input into the first transform device.

In various implementations, the first transform device and the second transform device share a common region of the substrate. For example, the first transform device may overlap with the second transform device within the common region of the substrate. In an example implementation, the first transform device may comprise a region of the substrate configured to receive light from the input waveguides. The region of the substrate may operate to diffract the plurality of optical signals, which can be sampled by each of the intermediate waveguides. The intermediate waveguides may then supply optical signals modulated by the modulation devices the same region of the substrate. The region of the substrate may diffract the modulated optical signals, which are sampled by the output waveguides. The region of the substrate may mimic functionality of a lens, which provides for optical signals supplied by each waveguide (e.g., input or intermediate waveguides) into the region of the substrate to be supplied to each of the receiving waveguides (e.g., the intermediate waveguides or the output waveguides).

Forming the first and second transform devices in a common region of the substrate can assist with reducing and possibly eliminating effects of thickness variability across the device. For example, semiconductor fabrication may result in variations in thickness of a device due process variations (e.g., due to manufacturing tolerances, a thickness of a device may vary across manufactured device within an acceptable tolerance). Providing the first and second transform devices at the same region of the substrate results in applying the same variation to all optical signals. That is, input optical signals supplied to the first transform device may be subject to the same thickness variations as subjected to the modulated optical signals by the second transform device. Thus, any errors (e.g., phase errors) may be negated by passing back through the same region of the substrate. As a result, the optical signals output from the second transform device may experience a reduction in phase errors relative to devices in which the first and second transform devices are formed in separate regions of the substrate.

In an example operation, an optical device according to the present disclosure may be implemented as a CONN. The CONN may be trained to learn weights, which may be implemented by adjusting the modulation devices to tune amplitude and phase modulation and apply the learned weights to optical signal propagating through the modulation device. To classify an input, input data is encoded onto a plurality of input optical signals, which are injected, by an optical source, into the plurality of input waveguides. The first transform device receives the input optical signals and performs the first transform (e.g., discrete optical Fourier transform) on the plurality of input optical signals to output Fourier transformed optical signals (referred to as intermediate optical signals) onto a plurality of intermediate waveguides. The modulation device acts upon the intermediate optical signals (sometimes referred to herein as first intermediate optical signals) to apply the learned weights to the Fourier transformed optical signals and the modulated intermediate optical signals (sometimes referred to herein as second intermediate optical signals) are supplied to the second transformed device. The second transform device performs the second transform (e.g., inverse discrete optical Fourier transform) on the modulated intermediate optical signals to output a plurality of inverse Fourier transformed optical signal (referred to as output optical signals) onto a plurality of output waveguides. The plurality of output optical signals may represent the convolution performed by the optical device and can be referred to herein as convolved optical signals. The plurality of output waveguides are coupled to the array of non-linear activation functions and photodetectors, which are activated or not based on the convolved optical signal.

The above implementations disclosed herein provide technical advantages over the conventional systems. For example, the technology disclosed herein can provide for reduced power consumption in executing CNN operations, reduced physical footprint, reduced computation time, heterogeneous integration into silicon-on-insulator (SOI) platforms, and reduced computational complexity on the order of at O(N² log₁₀(N)), compared to conventional approaches. The disclosed technology provides for a photonic device formed on a single substrate, thereby providing a much smaller footprint than achievable through the use of bulk optics of the conventional approaches. The SOI platform provides for the reduced power consumption by leveraging non-volatile memristive components to effectuate modulation. Furthermore, the reliance on light for performing CNN operations provide ultra-high-speed computations that can be used to reduced computation time, as well as the computational complexity.

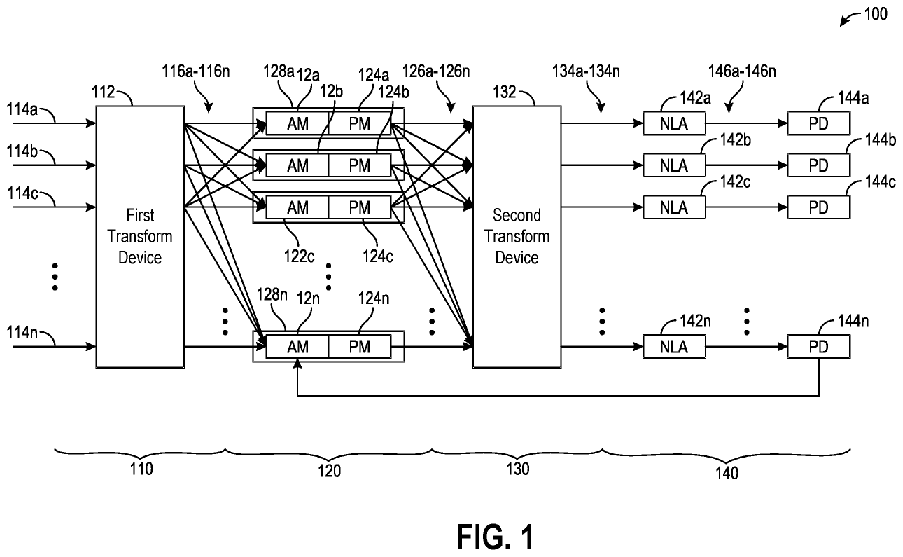

FIG. 1 is a schematic block diagram of a system architecture 100 for implementing a CONN in accordance with implementations of the present disclosure. System architecture 100 represents a photonic integrated circuit, which can be implemented as a monolithic device. System architecture 100 can be configured to perform a convolution of input data to infer a classification for the input data.

System architecture 100 comprises a first transform stage 110, an elementwise multiplication stage 120, a second transform stage 130, and an activation stage 140. The first transform stage 110 can be configured to transform a plurality of input signals 114a-114n (individually referred to herein as an input signal 114 as an illustrative example or collectively referred to herein as input signals 114) into a plurality of intermediate signals 116a-116n (individually referred to herein as an intermediate signal 116 as an illustrative example or collectively referred to herein as intermediate signals 116) by applying a first transformation to the input signals 114. The elementwise multiplication stage 120 receives the intermediate signals 116 and can be configured to apply learned weights to the intermediate signals 116 through elementwise multiplication. The elementwise multiplication stage 120 outputs modulated intermediate signals 126a-126n (individually referred to herein as a modulated intermediate signal 126 as an illustrative example or collectively referred to herein as modulated intermediate signals 126) to the second transform stage 130. The second transform stage 130 can be configured to transform the modulated intermediate signals 126a-126n by performing a second transformation (e.g., an inverse of the first transformation) and provide convolved signals 134a-134n to the activation stage 140. The activation stage 140 can be configured to activate the CNN based on the convolved signals 134a-134n.

First transform stage 110 comprises a first transform device 112. The first transform device can be configured to perform a first transformation on the input signals 114 to transform the input signals from a first domain to a second domain. In an example implementation, first transform device 112 can be configured to transform input signals 114 from a spatial (x, y) domain to a spatial frequency (kₓ, k_{y}) domain (also referred to as Fourier domain), where x and y denote spatial coordinates in an x, y plane and kₓ and k_{y} denote spatial frequencies. In an example implementation, first transform stage 110 performs a discrete optical Fourier transformation to the input signals, which outputs intermediate optical signals in the spatial frequency (kₓ, k_{y}) domain.

Elementwise multiplication stage 120 comprises a plurality of modulation devices 128a-128n (individually referred to herein as a modulation device 128 as an illustrative example or collectively referred to herein as modulation devices 128), which are provided as a plurality of amplitude modulators 122a-122n (individually referred to herein as an amplitude modulator 122 as an illustrative example or collectively referred to herein as amplitude modulators 122) and a plurality of phase modulators 124a-124n (individually referred to herein as a phase modulator 124 as an illustrative example or collectively referred to herein as phase modulators 124). In the example of FIG. 1, phase modulators 124 are downstream of amplitude modulators 122. However, the present disclosure is not intended to be limited to this configuration. For example, one or more phase modulators 124 may be upstream of one or more respective amplitude modulators 122. Furthermore, in the example of FIG. 1, each modulation device 128 is shown as a pair of one amplitude modulator 122 and one phase modulator 124. However, each modulation device may comprise of one or more amplitude modulators 122 and one or more phase modulators 124.

The modulation device 128 can be configured according to weights learned during training of the CONN. The learned weights may be provided as a weight matrix, where each entry of the weight matrix can be encoded into a single modulation device 128. Each pair of phase modulators 124 and amplitude modulators 122 can be tuned according to a value of an entry corresponding to a respective modulation device 128.

To implement elementwise multiplication, the first transform device 112 outputs each intermediate signal 116 to each modulation device 128 as shown in FIG. 1. That is, each modulation device 128 receives all of the intermediate signals 116. As such, each entry of the weight matrix is applied to entry of transformed input data by distributing all intermediate signals 116 across all of the modulation device 128. Modulation device 128 output modulated intermediate signals 126 to second transform stage 130. The modulated intermediate signals 126 represent a resulting product of the elementwise multiplication and is indicative of weighted signals.

Second transform stage 130 comprises a second transform device 132. The second transform device 132 can be configured to perform a second transformation on the modulated intermediate signals 126 to transform the intermediate signals 116 from the second domain to the first domain (e.g., an inverse transform of the first transformation). In an example implementation, second transform device 132 can be configured to transform intermediate signals 116 from the spatial frequency (kₓ, k_{y}) domain to the spatial (x, y) domain. In an example implementation, second transform device 132 performs an inverse discrete optical Fourier transformation to the intermediate signals 116, which outputs convolved signals 134 in the spatial frequency (kₓ, k_{y}) domain to the activation stage 140. In the example of FIG. 1, herein as modulated intermediate signals 126 from each of the modulation device 128 are supplied to each input of the second transform device 132, which second transform device 132 can then transform back to the spatial frequency domain.

Activation stage 140 comprises an array of non-linear activation devices 142a-142n (individually referred to herein as a non-linear activation device 142 as an illustrative example or collectively referred to herein as non-linear activation devices 142) and photodetectors 144a-144n (individually referred to herein as a photodetector 144 or as an illustrative example collectively referred to herein as photodetectors 144). Based on the magnitude of convolved signals 134, the non-linear activation devices 142 output activation signals 146a-146n (individually referred to herein as an activation signal 146 as an illustrative example or collectively referred to herein as activation signals 146) to the photodetectors 144. The input data can be classified based on which photodetector 144 detects an activation signal 146 having a magnitude that exceeds a defined threshold. For example, each photodetectors 144 may be associated with a label or class for labeling the input data. The input data can be associated (e.g., labeled) with the class corresponding to one or more photodetectors 144 that detect an activation signal 146 that exceeds the threshold. Where multiple photodetectors 144 detect activation signals 146 above the threshold, a probability for each respective class can be assigned based on the magnitude of the activation signal 146 relative to the magnitude of the other activation signals 146 (e.g., a higher magnitude translates to a larger probability).

Each of the non-linear activation devices 142 may be configured to implement a non-linear activation function. A non-linear activation function generates a sudden, non-linear detectable increase in an output based on a signal provided to the non-linear activation devices 142 meeting certain activation criteria (e.g., a magnitude of an optical power, wavelength, or polarization that activates the non-linearity of the non-linear activation devices 142). Examples of non-linear activation functions include, but are not limited to, sigmoid, radial-basis, rectified linear unit (ReLU) (such as ReLU, inverse ReLU, and leaky ReLU), and quadratic functions. When the criteria of an activation function implemented by a respective non-linear activation device 142 is met by a received convolved signal 134, the non-linear activation device 142 outputs a respective activation signal 146.

As described above, system architecture 100 can be implemented to execute a convolution operation. A convolution (r(x)={g*h}(x)) can be provided as:

$$r ( x ) = \{ g * h \} ( x ) = {F}^{- 1} \{ F \{ g \} ( f ) \cdot F \{ h \} ( f ) \} \qquad Eq . 1$$

where F and F⁻¹ are the discrete and inverse Fourier transforms, respectively and “·” is a Hadamard product or elementwise matrix multiplication operation. Thus, a convolution can be represented as the Hadamard product of the Fourier transformed functions F{g}(f) and F{h}(f)}.

In the case of system architecture 100, first transform device 112 can be implemented to apply a first transform that outputs F{g}(f) in the spatial frequency domain as intermediate signals 116, collectively. The intermediate signals 116 represent the input data transformed into the spatial frequency domain. Modulation device 128 can be encoded to implement F{h}(f) as a filter in the spatial frequency domain according to the weight matrix. By applying the filter onto the input data in the frequency domain via tuning of modulation device 128 and performing an inverse transform by second transform device 132 to transform the resulting product to the spatial domain, the convolution can be obtained as F⁻¹{F{g}(f)·F{h}(f)} as the output from the second transform device 132.

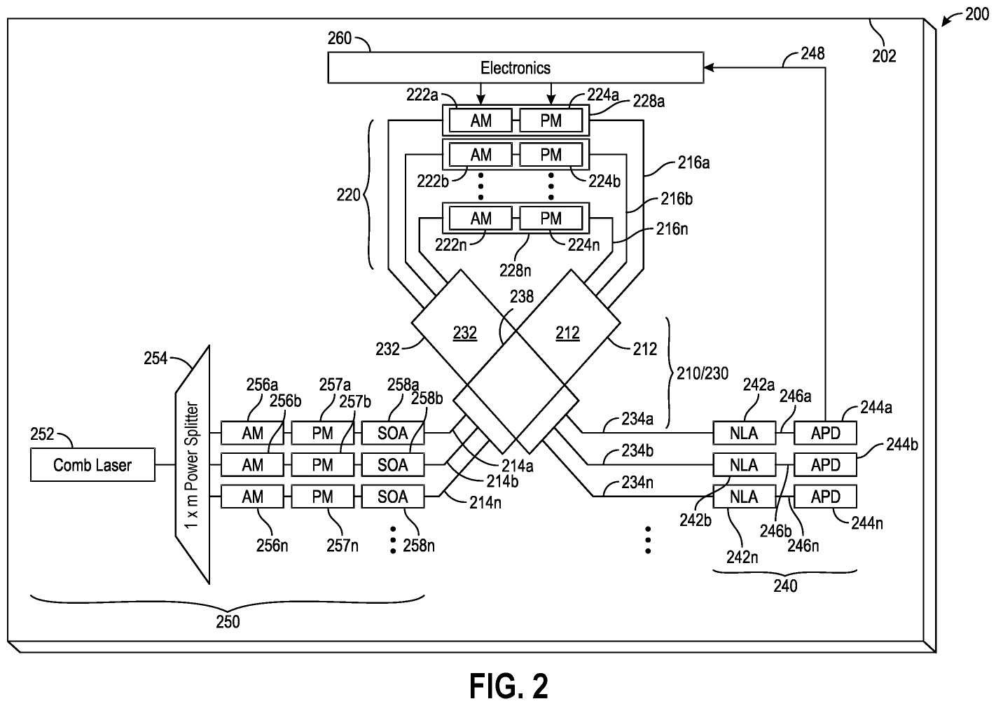

FIG. 2 is an schematic block diagram of an optical device 200 in accordance with implementations of the present disclosure. Optical device 200 is an example of a implementation of the system architecture 100 described above. Thus, optical device 200 can be provided to perform a convolution of input data to infer a classification.

Optical device 200 comprises a first transform stage 210, a elementwise multiplication stage 220, a second transform stage 230, and an activation stage 240. Optical device 200 also comprises an optical source 250 configured to supply input optical signals (e.g., an example of input signals 114) to a plurality of input waveguides 214a-214n (individually referred to herein as an input waveguide 214 as an illustrative example collectively referred to herein as input waveguides 214) coupled to the first transformation state 210. A plurality of intermediate waveguides 216a-216n (individually referred to herein as an intermediate waveguide 216 as an illustrative example or collectively referred to herein as intermediate waveguides 216) may optically couple to first transform stage 210 to second transform stage 230. The elementwise multiplication stage 220 may be provided along the intermediate waveguide 216 between first transform stage 210 and second transform stage 230. A plurality of output waveguides 234a-234n (individually referred to herein as an output waveguide 234 as an illustrative example or collectively referred to herein as output waveguides 234) optically couple the second transform stage 230 to activation stage 240. In the example of FIG. 2, optical device 200 is monolithically formed on a substrate 202, which may be provided as a silicon or other Group IV wafer substrate.

First transform stage 210 comprises a first transform device 212, which may be an example implementation of first transform device 112 of FIG. 1. First transform device 212 may be configured to receive input optical signals emitted by optical source 250 via input waveguides 214. First transform device 212 may be configured to split each input optical signal into a plurality of intermediate optical signals (e.g., an example of intermediate signals 116), which can be supplied to respective intermediate waveguides 216. In an example implementation, first transform device 212 is configured to supply a portion of each input waveguides 214 to each intermediate waveguide 216. Thus, first transform device 212 can be configured to transform the input optical signals from the first domain (e.g., spatial domain) to the second domain (e.g., spatial frequency domain) so to effectuate a discrete Fourier transformation of the input optical signals. As a result, the intermediate optical signals on the intermediate waveguide 216 at the output of the first transform device 212 represent a Fourier transformed functions F{g}(f) of Eq. 1. First transform device 212 may be implemented as a star-coupler, multimode interferometers (MMI), or the like.

Elementwise multiplication stage 220 comprises a plurality of modulation devices 228a-228n (individually referred to herein as a modulation device 228 as an illustrative example or collectively referred to herein as modulation devices 228), provided as a plurality of amplitude modulators 222a-222n (individually referred to herein as an amplitude modulator 222 illustrative example or collectively referred to herein as amplitude modulators 222) and phase modulators 224a-224n (individually referred to herein a phase modulator 224 as an illustrative example or collectively referred to herein as phase modulators 224). Modulation devices 228 may be an example implementation of modulation device 128 of FIG. 1. Each modulation device 228 can be formed along a respective intermediate waveguide 216, as shown in FIG. 2. As described above, modulation devices 228 can be tuned to effectuate a weight matrix so as to function as a filter to implement transformed function F{h}(f) in the spatial frequency domain.

Each phase modulator 224 can be controlled to adjust a phase of an intermediate optical signal output from first transform device 212 onto a respective intermediate waveguide 216. For example, each phase modulator 224 can be coupled to a section of a respective intermediate waveguide 216. A voltage bias can be applied to each phase modulator 224 that causes a change in a refractive index of the intermediate waveguide 216. The change in refractive index adjusts the phase of an optical signal traveling in the intermediate waveguide 216. Thus, selective control of the voltage bias applied to each phase modulator 224 can be utilized to tune refractive index of each respective intermediate waveguide 216, so to detune a phase of the intermediate optical signal output from first transform device 212. The magnitude of the voltage bias applied to a given phase modulator 224 can be dependent on the entry of the weight matrix corresponding to a respective modulation devices 228.

The phase modulator 224 can be implemented through thermal-optical tuning (e.g., a resistor coupled to the waveguide that generates heat based on an applied voltage), electro-optical tuning (e.g., coupling a PN diode to the waveguide), metal-oxide-semiconductor capacitor (MOSCAP) tuning, or the like. Example MOSCAP devices implemented as phase modulators are provided, for example, in U.S. Pat. Nos. 9,612,503; 11,355,899; 11,442,235; and Attorney Docket No. 61CT-377354, the disclosures of which are incorporated herein by reference in their entirety. In an example, where amplitude modulator 222 is implemented using MOCAP tuning, the elementwise matrix multiplication can be achieved through non-volatile memristive components, examples of which are provided in U.S. Pat. No. 11,355,899 and Attorney Docket No. 61CT-377354. The non-volatile memristive components can be implemented to achieve non-volatile phase detuning, which can provide for negligible power consumption by the non-volatile memristive components.

Each amplitude modulator 222 can be controlled to adjust an amplitude of an intermediate optical signal output from first transform device 212 onto a respective intermediate waveguide 216. For example, each amplitude modulator 222 can be provided along a section of a respective intermediate waveguide 216 and controlled to provide optical gain and/or optical loss to the optical signal. Thus, the magnitude of the gain and/or loss applied to a given amplitude modulator 222 can be dependent on the entry of the weight matrix corresponding to a respective modulation devices 228. The amplitude modulator 222 can be implemented as, but not limited to, one or more Mach-Zehnder Interferometers (MZIs), one or more micro-ring resonators (MRRs), or combinations thereof. In the case of an MZI, a coupling ratio of the MZI may be tuned to cause constructive and/or destructive interference at the output of the MZI so to provide optical gain (e.g., constructive interference) or optical loss (e.g., destructive interference). In the case of an MRR, an MRR may be provided so to evanescently couple an optical signal from a respective intermediate waveguide 216 and a resonance frequency of the MRR can be detuned relative to the frequency of the intermediate optical signal so to provide loss or tuned to coincide with the frequency of the intermediate optical signal to provide for optical gain.

The modulation devices 228 provide modulated intermediate signals that continue along the intermediate waveguide 216 to an input of the second transform stage 230. Second transform stage 230 comprises a second transform device 232, which may be an example implementation of second transform device 132 of FIG. 1. Second transform device 232 may be configured to receive modulated intermediate optical signals propagating in intermediate waveguide 216 and combine each modulate intermediate optical signal into the plurality of output waveguides 234 (e.g., an inverse of the first transform device 212). Thus, second transform device 232 can be configured to perform an inverse transform of the modulated intermediate optical signals from the second domain (e.g., spatial frequency domain) to the first domain (e.g., spatial domain) so to effectuate an inverse discrete Fourier transformation. As a result, second transform device 232 outputs convolved signals (e.g., signals 134) to the activation stage 240. Second transform device 232 may be implemented as a star-coupler, multimode interferometers (MMI), or the like.

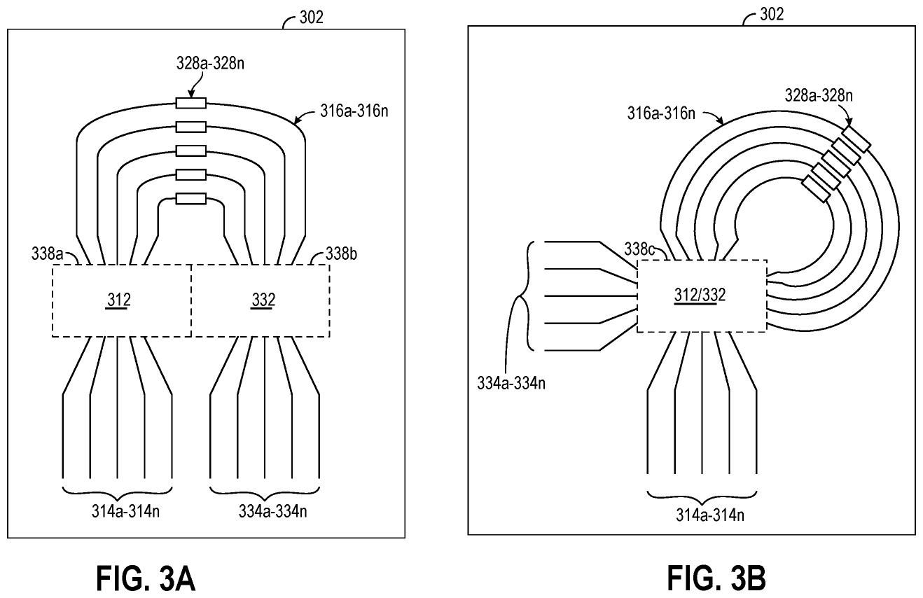

In various implementations, the second transform device 232 and the first transform device 212 share a common region of the substrate 202. For example, the first transform device 212 and the second transform device 232 may be formed within a common region 238 of the substrate 202. An example of this configuration is provided below connection with FIG. 3B, while a configuration in which the first and second transform devices 212 and 232 are in separate regions of substrate 202 is shown in FIG. 3A.

Activation stage 240 is an example implementation of activation stage 140 of FIG. 1. Activation stage 240 comprises a plurality of non-linear activation devices 242a-242n (individually referred to herein as a non-linear activation device 242 as an illustrative example or collectively referred to herein as non-linear activation devices 242) configured to emit activation optical signals (e.g., activation signal 146) onto a respective activation waveguide 246a-246n (individually referred to herein as an activation waveguide 246 as an illustrative example or collectively referred to herein as activation waveguides 246). Non-linear activation devices 242 may be substantially similar to non-linear activation devices 142 described above. While any non-linear activation device known in the art may be implemented as non-linear activation devices 242, some examples are provided in U.S. patent application Ser. No. 17/963,027 and U.S. patent application Ser. No. 17/972,927, the disclosures of which are incorporated herein by reference in their entirety. Another example of a non-linear activation device is an all-optical reconfigurable and ultra-low-threshold nonlinear activation function based on a high-Q microring resonator (MRR) assisted MZIs.

Activation stage 240 also comprises a plurality of photodetectors 244a-244n (individually referred to herein as a photodetector 244 as an illustrative example or collectively referred to herein as photodetectors 244), which are example implementations of photodetectors 144 of FIG. 1. As described above, based on the convolved optical signals on output waveguides 234, each of the non-linear activation devices 242 outputs an activation signal onto a respective activation waveguide 246 if characteristics of the convolved optical signal meets certain activation criteria. Example characteristics may include, but not limited to, a magnitude of the optical power of a respective activation signal, a wavelength of the respective activation signal, and a polarization of a respective activation signal, among others. For example, a given non-linear activation device 242 may be activated (e.g., outputs an activation signal) responsive to a received convolved optical signal having an optical power that exceeds a activation criteria of the non-linear activation device. As another example, a given non-linear activation device 242 may be activated responsive to receiving a convolved optical signal propagating at a wavelength that matches a wavelength of the non-linear activation device 242. The magnitude, polarization, and/or wavelength of the activation criteria is dependent on the design and implementation of the non-linear activation device.

The photodetectors 244 detect any activation optical signals on a respective activation waveguide 246. If the activation optical signal exceeds a set threshold, the input data can be labeled accordingly.

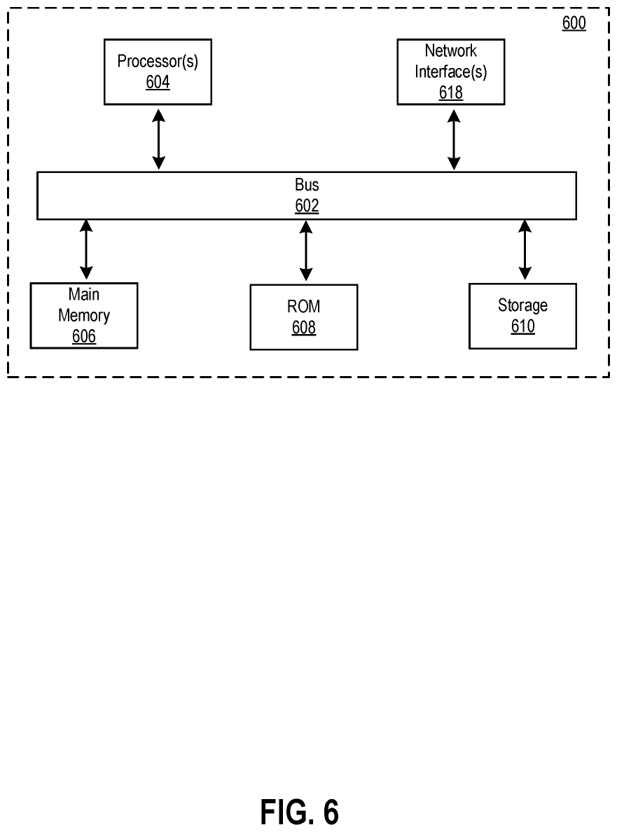

Optical device 200 also comprises control circuitry 260 that is configured to control the modulation devices 228. For example, control circuitry 260 may receive information indicative of a weight matrix and selectively control each amplitude modulator 222 and phase modulator 224 to encode the entries of the weight matrix into each modulation device 228. Control circuitry 260 may be implemented, for example, as computer system 600 of FIG. 6, described below. Control circuitry 260 may also comprise a power source that can be controlled by control circuitry 260 to apply a voltage bias to amplitude modulator 222. In another example, control circuitry 260 may be coupled (e.g., via a wired or wireless interface) to a power source, which control circuitry 260 can control for applying a voltage bias.

Optical device 200 may also comprise a feedback circuit 248 that communicatively couples (e.g., via a wired or wireless connection) the control circuitry 260 to each of the photodetectors 244. The feedback circuit 248 can be utilized by the control circuitry 260 to monitor optical power at the photodetectors 244 and tune the modulation devices 228 based on the detected optical power. For example, control circuitry 260 may tune the modulation devices 228 to maximize the optical power of an activation signal detected at the photodetectors 244. As an illustrative example, one or more of the non-linear activation devices 242 may be activated based on convolved optical signals on the output waveguides 234. The optical power of the convolved optical signals can be adjusted by tuning the modulation devices 228 so to maximize the response of the activated non-linear activation devices 242. The maximized response translates to maximizing the optical power of the activation signals generated by the non-linear activation devices 242.

Optical source 250 is an example optical source configured to generate input optical signals by emitting light and encoding the light with input data (e.g., image data in some examples) to provide input optical signals. In the example of FIG. 2, optical source 250 is provided as a comb laser 252 that emits an optical signal to a power splitter 254. The power split 254 splits the optical signal into a plurality of seed optical signals, each of which is supplied to an input waveguide 214. To encode input data onto each seed optical signal, amplitude modulators 256a-256n and/or phase modulators 257a-257n are provided that can be controlled to modulate the seed optical signal according to the input data. The modulated seed optical signals represent the input optical signals encoded with the input data. The modulated seed optical signals can then be provided to optical amplifiers 258a-258n (e.g., semiconductor optical amplifiers as known in the art), which are configured supply optical gain to each modulated seed optical signal and increase the optical power thereof. While FIG. 2 depicts a comb laser 252, other optical source can be utilized as long as coherency is maintained across the seed optical signals. For example, a plurality of optical source may be utilized, one for each input waveguides 214, to provide coherent inputs. In this case, power splitter 254 and optical amplifiers 258a-258n may not be necessary.

While FIG. 2 illustrates three input waveguides 214, three output waveguides 234, and three intermediate waveguide 216, the present disclosure is not limited to this configuration. The number of input waveguides 214 need not be the same as the number of intermediate waveguide 216. Similarly, the number of intermediate waveguide 216 may differ as well. The number of input waveguides 214 for a given implementation may be based on the input data, for example, the number of input waveguides 214 may correspond to the number of elements of the input date (e.g., number of pixels in the case of an input image). The number of intermediate waveguide 216 implemented may be dependent on the number of elements of the weight matrix and the number of second transform device 232 implemented may be dependent on the number of classes that optical device 200 is trained on.

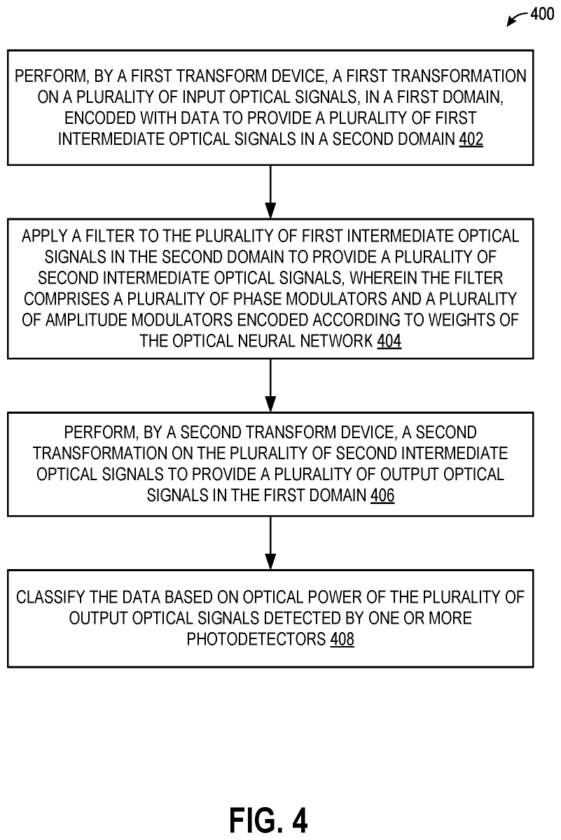

FIGS. 3A and 3B depict example implementations of a first and second transform devices in accordance with embodiments disclosed herein. The examples shown in FIGS. 3A and 4B may be example implementation of first transform device 212 and second transform device 232.

FIG. 3A illustrates an example implementation in which a first transform device 312 and a second transform device 332 are provided at different regions 338a and 338b of substrate 302. First transform device 312 may be an example of first transform device 212 and second transform device 332 may be an example of second transform device 232. Regions 338a and 338b of substrate 302 may collectively correspond to common region 238 of substrate 202. In this example, the first transform device 332 may be provided as a region 338a of the substrate 302. Input waveguides 314a-314n (e.g., examples of input waveguides 214) are optically coupled to the region 338a and inject input optical signals into the region 338a. The region 338a diffracts the input optical signals across the region. Intermediate waveguides 316a-316n (e.g., an example of intermediate waveguide 216) sample the diffracted input optical signals such that at least a portion of optical signals from each of input waveguides 314a-314n are received by each of intermediate waveguide 316a-316n resulting in intermediate optical signals. The intermediate optical signals are modulated by modulation devices 328a-328n (e.g., an example of modulation devices 228), for example, as described above in connection with FIGS. 1 and 2.

The modulated intermediate optical signals are supplied to the second transform device 332 via the intermediate waveguides 316a-316n. Intermediate waveguides 316a-316n are optically coupled to the region 338b and inject the modulated intermediate optical signals into the region 338b. The region 338b diffracts the input optical signals across the region. Output waveguide 334a-334n (e.g., an example of output waveguides 234) sample the diffracted modulated intermediate optical signals such that at least a portion of optical signals from each of intermediate waveguides 316a-316n are received by each of output waveguides 334a-334n, resulting in intermediate optical signals.

FIG. 3B illustrates an example implementation in which the first and second transform devices 312 and 332 are share a common region 338c (e.g., an example of modulation devices 228) of substrate 302. The operations of the example implementation of FIG. 3B are substantially similar to those described above in connection with FIG. 3A, except that first transform device 312 and second transform device 332 share common region 338c. Thus, any variations in common region 338c due to fabrication tolerances can be mitigated by passing the input optical signals and the modulated intermediate optical signals through the same region of substrate 302. Thus, any thickness variation induced errors may be negated.

FIG. 4 is an example flow chart 400 of operations for implementing an optical neural network in accordance with the implementations disclosed herein. Flow chart 400 can be implemented as instructions stored in a memory that can be executed by a hardware processor to perform the operations of flow chart 400. The memory and hardware processor may be embodied as those described in connection with FIG. 6 below.

At operation 402, a first transformation may be performed, by a first transform device, on a plurality of input optical signals to provide a plurality of first intermediate optical signals in a second domain. The plurality of input optical signals may be provided in a first domain and encoded with data. According to an example implementation, the first domain may be a spatial domain and the second domain may be a spatial frequency domain. The first transformation device may implemented as first transform device 112 and/or first transform device 212 of FIGS. 1 and 2, respectively.

At operation 404, a filter may be applied to the plurality of first intermediate optical signals in the second domain to provide a plurality of second intermediate optical signals. The filter comprises a plurality of phase modulators and a plurality of amplitude modulators encoded according to weights of the optical neural network. In various examples, as described above in connection with FIGS. 1 and 2, the plurality phase modulators and the plurality of amplitude modulators may be tuned based on a weight matrix comprising the weights. The plurality of phase modulators may be provided as phase modulators 124 and/or phase modulator 224 of FIGS. 1 and 2, respectively. The plurality of amplitude modulators may be provided as modulation device 128 and/or modulation devices 228 of FIGS. 1 and 2, respectively.

At operation 406, a second transformation may be performed, by a second transform device, on the plurality of second intermediate optical signals to provide a plurality of output optical signals in the first domain. The second transformation device may implemented as second transform device 132 and/or second transform device 232 of FIGS. 1 and 2, respectively.

At operation 408, the data may be classified based on optical power of the plurality of output optical signals detected by one or more photodetectors. The photodetectors may be implemented as photodetectors 144 and/or photodetectors 244 of FIGS. 1 and 2, respectively.

According to some examples, classifying the data based optical power of the plurality of output optical signals detected by one or more photodetectors at operation 408 may be based on activating one or more non-linear activation devices (e.g., non-linear activation devices 142 of FIG. 1 and/or non-linear activation devices 242 of FIG. 2). Activation of one or more non-linear activation devices may be based on the optical power of the output optical signals received at the non-linear activation devices. For example, where the optical power of an output optical signal received by one or more non-linear activation devices exceeding an activation criteria. Responsive to activation, the one or more non-linear activation devices output one or more activation signals to the one or more photodetectors, which detect an optical power of the one or more activation signals. Responsive to the detected optical power exceeding a threshold, the data can be classified according to a class associated with the one or more photodetectors.

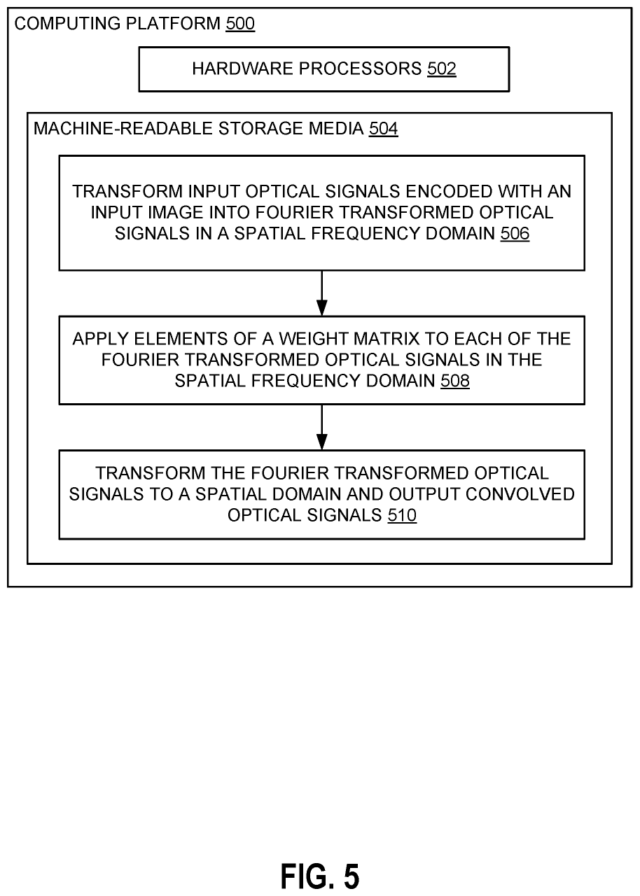

FIG. 5 illustrates an example computing component that may be used to implement an ONN in accordance with various embodiments. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-510, to control processes or operations for implementing an ONN. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-510.

Hardware processor 502 may execute instruction 506 to transform input optical signals encoded with an input image into Fourier transformed optical signals in a spatial frequency domain. In various example, instruction 506 can be based on an optical Fourier transformation device formed on the substrate. As described in FIGS. 1 and 2, first transform device 112 and/or first transform device 212 may be implemented as Fourier transformation device.

Hardware processor 502 may execute instruction 508 to apply elements of a weight matrix to each of the Fourier transformed optical signals in the spatial frequency domain. In various examples, instruction 508 can be based on a plurality of modulation devices formed on the substrate and optically coupled to the optical Fourier transformation device. As described in FIGS. 1 and 2, the plurality of modulation devices may include pairs of modulation devices 128 and phase modulators 124 or pairs of modulation devices 228 and phase modulators 224. In either case, as described above, the amplitude modulators and/or phase modulators can be tuned so to change an amplitude and/or phase of an optical signal passing through the modulation device in order to apply an element of the weight matrix to the optical signal.

Hardware processor 502 may execute instruction 510 to transform the Fourier transformed optical signals to a spatial domain and output convolved optical signals. According to various example, instruction 510 can be based on an inverse optical Fourier transformation device formed on the substrate and optically coupled to the plurality of modulation devices. As described in FIGS. 1 and 2, second transform device 132 and/or second transform device 232 may be implemented as the inverse Fourier transformation device. In either case, an output from the inverse Fourier transformation device can be provided to an array of non-linear activation devices and photodetectors. The non-linear activation devices may be activated (e.g., output a non-linear response) to the photodetectors, which detect an optical signal for classifying the input image, as described above in connection with FIGS. 1 and 2.

FIG. 6 depicts a block diagram of an example computer system 600 in which various implementations described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 may also be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein, such as, but not limited to, processes described in connection with FIG. 4 and/or those executed by the instructions described in connection with FIG. 5. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical device for implementing an optical neural network, the optical device comprising:
a plurality of input waveguides configured to receive a plurality of input optical signals;
a first transform device coupled to the plurality input waveguides and configured to perform a first transform of the input optical signals to output a plurality of intermediate optical signals;
a plurality of intermediate waveguides that receive the plurality of intermediate optical signals from the first transform device, each intermediate waveguide comprising a phase modulator and an amplitude modulator;
a second transform device coupled to the intermediate waveguides and that receives the plurality of intermediate optical signals, the second transform device configured to perform a second transform of the plurality of intermediate optical signals and output a plurality of output optical signals; and
an array of non-linear activation devices and photodetectors that receive the plurality of output optical signals,
wherein the optical device is monolithically formed on a substrate.

2. The optical device of claim 1, wherein the second transform is an inverse of the first transform.

3. The optical device of claim 1, wherein the input signals are provided in a spatial domain and the intermediate optical signals are provided in a spatial frequency domain.

4. The optical device of claim 1, wherein the first transform device comprises one of: one or more star-couplers and one or more multimode interferometers.

5. The optical device of claim 4, wherein the second transform device comprises one of: one or more star-couplers and one or more multimode interferometers.

6. The optical device of claim 1, wherein the phase modulators comprise one or more of a resistor, a PN diode, a metal-oxide-semiconductor capacitor.

7. The optical device of claim 1, wherein the amplitude modulators comprise one or more of a Mach-Zehnder Interferometer and a micro-ring resonator.

8. The optical device of claim 1, wherein the first transform device, the phase modulators, the amplitude modulators, and the second transform device are configured to perform a convolution of input data encoded onto the input optical signals.

9. The optical device of claim 1, wherein the first transform device and the second transform device are formed at a common region of the substrate.

10. A method of implementing an optical neural network, comprising:
performing, by a first transform device, a first transformation on a plurality of input optical signals, in a first domain, encoded with data to provide a plurality of first intermediate optical signals in a second domain;
applying a filter to the plurality of first intermediate optical signals in the second domain to provide a plurality of second intermediate optical signals, wherein the filter comprises a plurality of phase modulators and a plurality of amplitude modulators encoded according to weights of the optical neural network;
performing, by a second transform device, a second transformation on the plurality of second intermediate optical signals to provide a plurality of output optical signals in the first domain; and
classifying the data based on optical power of the plurality of output optical signals detected by one or more photodetectors.

11. The method of claim 10, wherein the first transform device, filter, and second transform device are formed on a single substrate.

12. The method of claim 11, wherein the first transform device and the second transform device are formed at a common region of the substrate.

13. The method of claim 10, further comprising:
tuning the plurality phase modulators and the plurality of amplitude modulators based on a weight matrix comprising the weights.

14. The method of claim 10, wherein the first domain is a spatial domain and the second domain is a spatial frequency domain.

15. The method of claim 10, wherein at least one of the first transform device and the second transform device comprises one of: one or more star-couplers and one or more multimode interferometers.

16. The method of claim 10, wherein classifying the data based optical power of the plurality of output optical signals detected by one or more photodetectors comprises:
activating one or more non-linear activation devices based on the optical power of the output optical signals, wherein the one or more non-linear activation devices output one or more activation signals to the one or more photodetectors;
detecting an optical power of the one or more activation signals by the one or more photodetectors; and
responsive to the detected optical power exceeding a threshold, classifying the data according to a class associated with the one or more photodetectors.

17. The method of claim 10, wherein the phase modulators comprise one or more of a resistor, a PN diode, a metal-oxide-semiconductor capacitor.

18. The method of claim 10, wherein the amplitude modulators comprise one or more of a Mach-Zehnder Interferometer and a micro-ring resonator.

19. The method of claim 10, wherein the first transform device, the filter, and the second transform device perform a convolution of the data.

20. An optical convolution neural network, comprising:
a substrate;
an optical Fourier transformation device formed on the substrate and configured to transform input optical signals encoded with an input image into Fourier transformed optical signals in a spatial frequency domain;
a plurality of modulation devices formed on the substrate and optically coupled to the optical Fourier transformation device, the plurality of modulation devices configured to apply elements of a weight matrix to each of the Fourier transformed optical signals in the spatial frequency domain; and
an inverse optical Fourier transformation device formed on the substrate and optically coupled to the plurality of modulation devices, the inverse optical Fourier transformation device configured to transform the Fourier transformed optical signals to a spatial domain and output convolved optical signals,
wherein the input image is labeled with a class based on the convolved optical signals.
